(19) United States
(12) Patent Application Publication
(10) Pub. No.: US 2006/0293158 A1
(43) Pub. Date: Dec. 28, 2006

(54) Method of manufacturing a food container

(75) Inventor: Shinkichi Hamano, Katsushika-ku (JP)

Correspondence Address: JORDAN AND HAMBURG LLP, 122 EAST 42ND STREET, SUITE 4000, NEW YORK, NY, 10168, US

(73) Assignee: Isamu SATO, Setagaya-ku (JP)

(21) Appl. No.: 11/472,682

(22) Filed: Jun. 22, 2006

(30) Foreign Application Priority Data
Jun. 23, 2005 (JP) 2005-183903

(51) Int. Cl. B31B 1/62

(52) U.S. Cl. 493/143

(57) ABSTRACT

A low cost method of commercially manufacturing a food container of practical strength from vegetable-fiber material includes the steps of: forming aboard of a predetermined size from pulp and at least one kind of vegetable fiber material other than the pulp; coating the board with thermoplastic resin having a heat sealing property; providing for forming the folding portions for connecting adjacent sidewall pieces at four corners of the board; and hot-pressing the board thus obtained using a pair of press dies to form the food container, the pair of dies being composed of female die and male die, wherein one of the pairs of opposing sidewall pieces is arranged to be erected prior to the other pair of opposing sidewall pieces and four corners are bonded correspondingly each other by a hot press process in order to form the container.

### BACKGROUND OF THE INVENTION

1. Field of the Invention

The present invention relates to a method of manufacturing a food container or covers formed of vegetable fiber material, more specifically, to a method of manufacturing the food container or covers formed of the vegetable fiber material commercially at low cost.

2. Related Background of the Invention

Conventional food containers for containing food, such as lunch boxes or trays, are made of plastic materials like foamed polyeurethane and so on. However, since the plastic materials have a problem in disposing them after use, vegetable-fiber-made food containers are strongly required in view of the environment conservation.

However, there has been a problem in manufacturing the vegetable-fiber-made food containers by die molding process that only shallow containers with insufficient strength could be manufactured. Further, in the case of the containers made from pulp board, there has been a problem of costly manufacturing, since the containers are so manufactured that cuts are formed at four corners, sidewall pieces are erected, edges of the sidewall pieces are brought into superposition to each other to apply bonding agent, and the bonded portions are manually fixed. As a consequence thereof, the vegetable-fiber-made food containers are not widely diffused comparing to the other food containers, e.g., cheap trays as presently sold in supermarkets.

In addition, paper-made containers that have a number of bellows-like wrinkles formed at the corner portions and the surface is coated with film have also been known. However there has been a problem of extremely expensive cost.

Meanwhile, with regard to paper as vegetable-fiber-made material, the natural forest including the virgin forest is to be deforested for raw material of paper. However, it is a current issue to deforest the natural or virgin forest not only from view point of natural ecosystem where various animals inhabit but also from local environmental disruption view point.

### SUMMARY OF THE INVENTION

An object of the present invention is to provide a method of manufacturing a vegetable-fiber-material made food container which has a practical strength and can be manufactured commercially at low cost.

Another object of the present invention is to provide a method, considering a problem as to a global environment, of manufacturing the vegetable-filer-material made food container at low cost, capable of reducing an amount of pulp to be used therefor.

The above stated objects can be achieved with the present invention by employing the steps of: forming a board having a predetermined size of pulp and at least one kind of the vegetable fiber material other than the pulp; coating thermoplastic resin having heat sealing property onto the board; providing for forming the folding portions for connecting adjacent sidewall pieces at four corners of the board; and forming the food container with thus obtained board subjected to a hot press process with a pair of press dies, male and female dies, in which a pair of the sidewall pieces opposing to each other are arranged to be erected prior to another pair of the sidewall pieces opposing to each other.

It is specifically preferable to apply the thermoplastic resin having the heat sealing property onto one of the surfaces (either one of a front or rear surface) of the board for the purpose of coating, since it can be cost effectively substituted for plastic material and is printable thereon. Practically, if the coating is provided on both sides of the board, it becomes more expensive than using the plastic material in the current technique, which does not allow substitution for plastic material.

It is preferable to form the folding portions for connecting so as to be bonded with the sidewalls in a state that the folding portions are folded uprightly. It is also preferable to form the folding portions to be substantially V-shaped to bond in overlapping manner with the sidewalls after folding at the center of the V-shape in a mountain shape to put the both sides together.

In this case, it is preferable to form a notch at the top end of the folding portion on the abutting side of the same against the one sidewall in overlapping manner for bonding, after the substantially V-shaped folding portion is folded at the center thereof in a mountain shape, so that the rear surface of the other side of the folding portion is directly abutted for bonding against the front surface of aforementioned one sidewall.

Moreover, especially in the case where to fold up the folding portion in a smaller angle below 90 degrees, it is preferable to form the folding portion for connecting in substantially V-shape and fold it as V-shape to bond in overlapping manner with the sidewall. In this case, it is preferable to form a notch at the top end of the substantially V-shaped folding portion so that the front surface of the sidewall with which the folding portion is bonded in overlapping manner and the rear surface of the other sidewall interposing the notch therebetween are abutted to be bonded together. According to the constitution described in claims 5 and 7, coating of thermoplastic resin having heat sealing property on the front surface only can perform bonding the corner portion effectively.

Such an arrangement that a protruded portion is formed at one of the opposing sections of an opening periphery of the female die so that the pair of opposing sidewall pieces placed on the protruded portion is erected earlier than the other pair of the opposing sidewall pieces can make it possible to manufacture food containers at commercially low cost, four corners of containers being attached together through the hot press process using dies.

In a case of manufacturing the container with a sword guard shaped section, the opposing protruded portions are configured so as to be away from the concaved periphery of the female die at least by a distance corresponding to the sword guard shaped section of the container to be formed.

Before the pressing process, if one pair of the opposing sidewall pieces, which are arranged to be erected prior to the other pair of the opposing sidewall pieces, is bent, conventional dies can be employed to manufacture the container. However, when considering the productivity of the container, the above stated arrangement will be more preferable to produce the container.

It is preferable that the pulp and at least one kind of the vegetable fiber material other than the pulp are made of mixture of the pulp and the vegetable fiber material other than the pulp in view of the protection of the global environment destruction due to deforestation.

It is preferable that the vegetable fiber material other than the pulp be made of reed, sugar cone or kanaf.

It is preferable that a rate of the pulp and the vegetable fiber material other than the pulp be adjusted so that the vegetable fiber material other than the pulp is between 20 and 80 wt % with respect to the pulp. The less degrees, the less effect to the protection of the global environment, and the more degrees, the less strength and the less adhesive ability of an adhering section.

It is preferable to employ polyethylene or polypropylene as the thermoplastic resin having the heat sealing property according to the present invention.

Further, according to claim 10 of the present invention, a food container, being formed of vegetable fiber material which is cheap and uses reduced amount of pulp, can be obtained, thereby contributing to protection of the global environment destruction due to deforestation.

### BRIEF DESCRIPTION OF THE DRAWINGS

FIG. 1 is a perspective view illustrating one embodiment of a food container according to the present invention.

FIG. 2 is a partial developed view illustrating another embodiment of a food container according to the present invention.

FIG. 3 is a perspective view illustrating an example of a female die to be used in the present invention.

### DESCRIPTION OF THE PREFERRED EMBODIMENTS

Next an embodiment of the present invention is described.

The present invention is composed of the following processes.

(1) The board of the predetermined size is formed of the pulp and at least one kind of the vegetable fiber material other than the pulp.

(2) Thermoplastic resin having the heat sealing property is applied to the board.

(3) A folding line is formed on the aforementioned board.

(4) Thus obtained board is subjected to the hot press process using a pair of press dies, male and female in order to form the food container.

The process (1) can be performed by a known method of manufacturing the board from pulp. More specifically, the board is obtainable through the processes that pulp suspended in water is subjected to a sheet-forming process, followed by a water-squeezing process and drying process. The board thus obtained is cut into developed shape of a container or a cover thereof to be formed. It is preferable that the board contain water proof agent.

As the vegetable-fiber-made material other than the pulp used in the present invention, it is preferable to use reed, sugar cone or kanaf. More specifically, using the reed is preferred since it is excellent in strength of the resultant container.

In the present invention, it is preferable to use a mixture of the pulp and the vegetable fiber material other than the pulp in view of the protection of the global environment due to the deforestation.

As to the rate of the pulp and the vegetable fiber material other than the pulp, it is preferable that the vegetable fiber material other than the pulp be between 20 and 80 wt %, more preferably between 30 and 60 wt %. The less addition of the vegetable fiber material, the less effect in protection of the global environment, while the more addition of the vegetable fiber material, the less strength and the more tendency of abruption of the bonding section.

The process (2) in which the thermoplastic resin having the heat sealing property is applied to the board in a coating manner may be done after a formation of the cuts or may be done before the formation of the cuts; however, the coating process is done before the formation of the cuts in the present embodiment. The thermoplastic resin is preferably applied to either surface, front or rear, of the board. If the thermoplastic resin is applied to both surfaces, diffusion of the container according to the present invention will be adversely effected for the reason of an expensiveness of the container at present and further no printable surface is obtained. In addition, the thermoplastic resin is preferred to be applied to the surface on which the food is placed. The reason for applying coating on the surface on which the food is placed is that the coating prevents juice or the like from infiltrating into the container. As the thermoplastic resin, it is preferable to use especially polyethylene or polypropylene.

A content of the thermoplastic resin differs depending on the kinds of the thermoplastic resin. Here, a range between 2 and 10% with respect to a mass of the board, more preferably, between 3 and 6% with respect to the mass of the board. Here, the “content” is represented by a percentage of the “mass of the heat sealing agent to be applied to the board” with respect to the entire mass of the board of which one surface is applied with the thermoplastic resin.

The folding line in the process (3) is preferably formed by a blanking die. That is, the folding lines between the bottom and the side, the side and the folding portion, and the like are formed by pressing a board placed on a blanking die having projected lines thereon, thus the folding lines are formed. As a matter of course, other means may be applicable to form the folding lines.

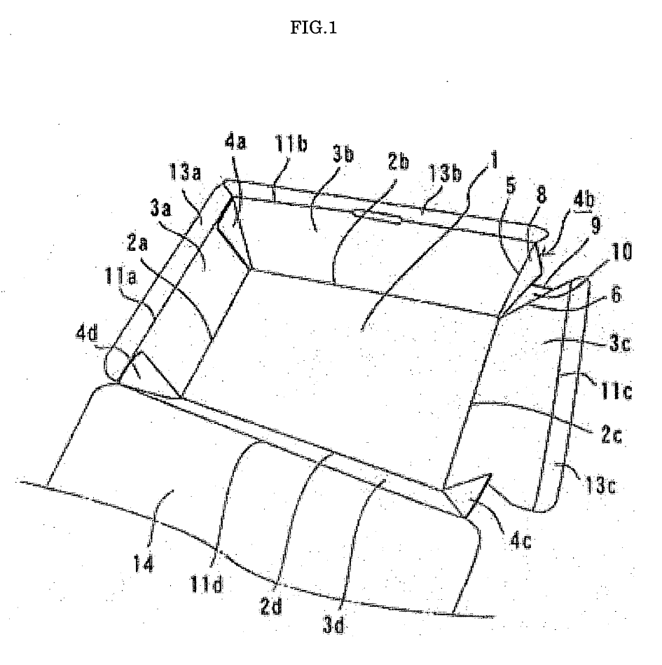

FIG. 1 is a perspective view illustrating one embodiment of a food container according to the present invention. Note that, for convenience of explanation, a part of the sidewall is shown in a state developed.

The sidewalls (side plane pieces) 3a, 3b, 3c and 3d are provided consecutively with the bottom plate 1 via the folding lines 2a, 2b, 2c and 2d. The adjacent sidewalls 3a/3b, 3b/3c, and 3c/3d are connected with the folding portions 4a, 4b, 4c and 4d via the folding lines 5 and 6.

The folding portions 4a to 4d are formed in substantially V-shape and a folding line 7 is formed at the center of the V-shape so that the folding line can be folded towards inside of the contained in a mountain shape. The folding portions 4a to 4d are composed of a long substantially V-shaped folding portion 8 and a short substantially V-shaped folding portion 10 having a notch 9 formed at the upper top thereof.

Since the above mentioned food container is coated with the thermoplastic resin having the heat sealing property only on the front surface, the long substantially V-shaped folding portion 8 and the short substantially V-shaped folding portion 10 are not bonded to fix unless the notch 9 is formed. In the above embodiment, since the notch 9 is formed, the top of the long substantially V-shaped folding portion 8 and the sidewall 3c is bonded, and consequently the long substantially V-shaped folding portion 8 and the short substantially V-shaped folding portion 10 are fixed.

The sword guard shaped portions 13a, 13b and 13c are provided consecutively on the top end of the sidewalls 3a, 3b and 3c via the folding lines 11a, 11b and 11c, and the sidewall 3d is provided with a cover 14 via the folding line 11d.

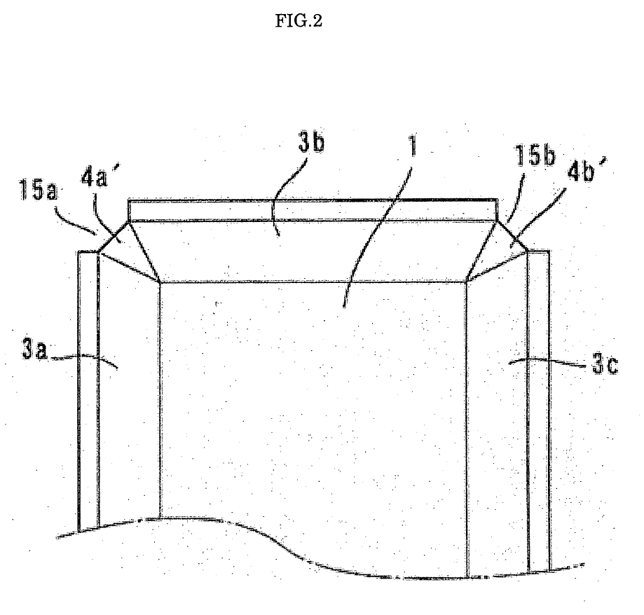

FIG. 2 shows another embodiment according to the present invention. Folding pieces 4a′ and 4b′ connecting the sidewalls 3a and 3b, and 3b and 3c respectively are formed in substantially V-shape, and the folding portions 4a′ and 4b′ are arranged to be folded as V-shape and then bonded with the sidewall 3a, 3c or 3b in overlapping manner.

At the top end of the substantially V-shaped folding portions 4a′ and 4b′, the notches 15a and 15b are formed. The front surface of the sidewall on which the folding portion is overlapped for bonding thereto and the rear surface of the other sidewall interposing the aforementioned notch are arranged to be abutted for bonding.

In order to form the food container by means of a pair of hot press dies consisted of the male die and the female die in accordance with the process (4), one of the pairs of the opposing sidewall pieces of the board on which cuts are formed as illustrated in FIGS. 1 to 2 is erected prior to the other pair of the opposing sidewall pieces and the board thus formed is placed in the female die to be subjected to a hot pressing process by the upper male die in order to form the container, and simultaneously, the board is subjected to the heat sealing process In the embodiment of FIG. 1, the opposing sidewalls 3b and 3d (not shown) have to be erected prior to the others. This is because the sidewalls connected to the long substantially V-shaped folding portion 8 are required to be erected primarily. When the order is reversed, the folding portions 4a and 4b are bonded with the sidewall 3b and as a result the long substantially V-shaped folding portion 8 and the short substantially V-shaped folding portion 10 are not fixed.

In the embodiment of FIG. 2, either pair of the opposing sidewall pieces may be erected prior to the other pair; however, it is preferable for the pair of short sidewall pieces 3b, 3d not shown to be erected prior to the other pair since it is easier. When the short sidewall 3b and 3d (not shown) are erected prior to the others, the folding portions 4a′ and 4b′ are bonded with the sidewall 3a and 3c respectively, while when the long sidewall 3a and 3c are erected prior to the others, both of the folding portions 4a′ and 4b′ are bonded with the sidewall 3b.

If the sidewall pieces are preliminary erected by means of a paper folding machine, a conventional press dies can also be utilized to form the container.

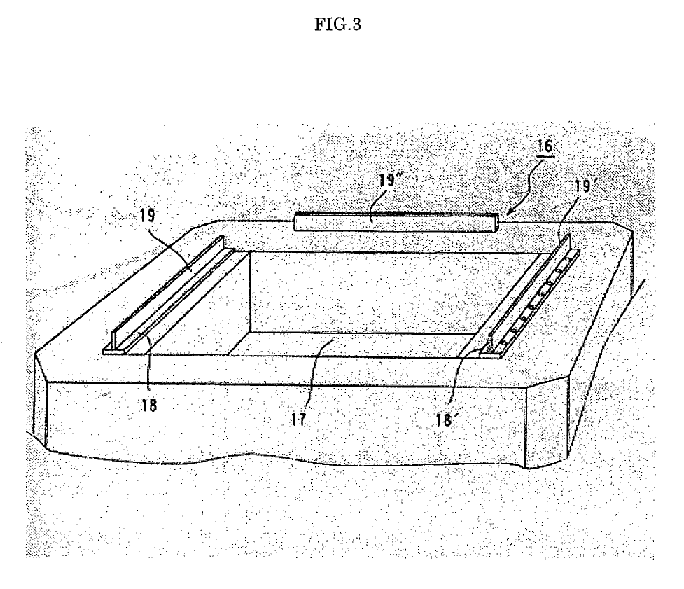

FIG. 3 illustrates an example of a female die (concave die) 16 to be used in manufacturing according to the present invention, in which opposing sections at short side surfaces of the upper periphery of the concave section 17 of the female die 16 are provided with rods 18, 18′ having square shapes in cross section in a manner opposing to each other and slightly spaced from the concave section 17. On the rods 18, 18′, guiding boards 19, 19′ are provided to stand thereon. At a backside of the concave section 17 of the female die 16, a guiding board 19″ is provided to stand thereon.

The board illustrated in FIG. 2 is placed so that the pair of short sidewall pieces 3b, 3d (not shown) is held between the guiding plates. 19, 19′ and one of the long sidewall pieces 3a or 3c is abutted on a guide plate 19″ via the rods 18, 18′ on the concave section 17 of the female die 16. Then, the male die (convex die) (which is not shown) is descended and brought into fit with the concave section 17 of the female die 16 from the above to be subjected to the hot pressing process.

Accordingly, the pair of the opposing sidewall pieces 3b, 3d (not shown) is erected prior to the other pair of the opposing sidewall pieces 3a, 3c, and then the container can be manufactured in a single step by a complete fitting and the hot pressing process. Note that, as shown in FIG. 2, the sword guard shaped section 13a′˜13d′ provided at an upper edge and the concave sections 17 of the container are formed by the hot pressing process using the male and female dies.

In order to form the sword guard shaped section 13a′˜13d′ on the upper edge of the container, as shown in FIG. 3, the rods 18, 18′ are away from the both side ends of the concave section by the distance corresponding to the sword guard shaped section. The concave section 17 may include steps formed thereon, and the male die is formed into a shape including the steps so as to fit into the concave section. The sword guard shaped section may be obviously formed utilizing the steps at which the female die and the male die are closely contacted with each other.

Manufacturing of containers shown in FIG. 1 requires that the concave section 17 is a long-shaped die in the longitudinal direction since the long sidewalls 3b and 3d have to be erected primarily.

A cover can be consecutively formed with the container of the present invention. In the case of forming the consecutive cover, the cover may be formed consecutively with the sidewall piece (preferably with either one of the sidewall pieces 3, 3′) as shown in FIGS. 1.

As shown in FIG. 1, corner sections at four corners are thick because portions of the board are superimposed each other, consequently portions of the female die and/or the male die at which the corner sections are formed are preferred to be thinned by that amount.

The food containers manufactured by the method according to the present invention are not limited to, but are suitable for the use of lunch boxes, fermented soybeans containers, trays, covers of the lunch boxes, and the like.

According to the present invention, the food container formed of the vegetable-fiber-made material and having practical strength can be produced commercially at low cost, therefore the container according to the present invention is sufficient enough as an alternative to the food container made of plastic, resulting in remarkably contributing to the environment protection.

Moreover overlapped bonding after cutting the material and coating the thermoplastic resin having heat sealing property only on the front surface causes liquid penetration from the cut surface of bonding portion at the corner, resulting leakage and seeping. On the contrary, the container according to the present invention does not have such concern since there is no cut surface at the corners.

What is claimed is:

1. Manufacturing method of food containers or covers thereof comprising the steps of:
forming a board of a predetermined size from pulp and at least one kind of vegetable fiber material other than the pulp;
coating the board with thermoplastic resin having a heat sealing property;
providing for forming the folding portions for connecting adjacent sidewall pieces at four corners of the board; and
hot-pressing the board thus obtained using a pair of press dies to form food containers or covers of the containers, a pair of dies being composed of female die and male die;
wherein one pair of the opposing sidewall pieces is arranged to be erected prior to the other pair of opposing sidewall pieces.

2. The manufacturing method as claimed in claim 1, wherein said thermoplastic resin having the heat sealing property is applied to one of surfaces of the board to provide coating on outside of the food container or covers formed.

3. The manufacturing method as claimed in claim 1 or 2, wherein the folding portions for connecting is formed so as to be bonded with the sidewalls in a state that the folding portions are folded uprightly.

4. The manufacturing method as claimed in claim 3, wherein the folding portions for connecting is formed to be substantially V-shaped to bond in overlapping manner with the sidewalls after folding at the center of the V-shape in a mountain shape to put the both sides together.

5. The manufacturing method as claimed in claim 4, wherein a notch is formed at the top end of the folding portion on the abutting side of the same against the one sidewall in overlapping manner for bonding, after the substantially V-shaped folding portion is folded at the center thereof in a mountain shape, so that the rear surface of the other side of the folding portion is directly abutted for bonding against the front surface of aforementioned one sidewall.

6. The manufacturing method as claimed in claim 1, wherein the folding portion for connecting is formed in substantially V-shape and fold it as V-shape to bond in overlapping manner with the sidewall.

7. The manufacturing method as claimed in claim 6, wherein a notch at the top end of the substantially V-shaped folding portion is formed so that the front

8. The manufacturing method as claimed in claim 1, wherein a protruded portion is formed at one of the opposing sections of an opening periphery of the female die so that the pair of opposing sidewall pieces placed on the protruded portion is erected earlier than the other pair of the opposing sidewall pieces.

9. The manufacturing method as claimed in claim 8, wherein guides for holding side edges of the board is provided at the opposing protruded portions or at adjacent positions thereto.

10. The manufacturing method as claimed in claim 9, wherein one of the other opposing surfaces of the concave periphery of the female die is provided with a guide to which one of the other side edges of the board abuts.

11. The manufacturing method as claimed in claim 1, wherein one pair of the opposing sidewall pieces is bent before performing the pressing process, and arranged to be erected prior to the other pair of the opposing sidewall pieces.

12. The manufacturing method as claimed in claim 1, wherein the pulp and at least one kind of the vegetable fiber material other than the pulp is a mixture of the pulp and the vegetable fiber material other than the pulp.

13. The manufacturing method as claimed in claim 12, wherein the vegetable fiber material other than the pulp is reed, sugar corn, or kanaf.

14. The manufacturing method as claimed in claim 13, wherein a rate of the pulp and the vegetable fiber material other than the pulp is defined such that the vegetable fiber material other than the pulp is between 20 and 80 wt % with respect to an entire mass of the board.

15. The manufacturing method as claimed in claim 1, wherein the thermoplastic resin having the heat sealing property is polyethylene or polypropylene.
